(19) United States
(12) Patent Application Publication
(10) Pub. No.: US 2023/0406740 A1
(43) Pub. Date: Dec. 21, 2023

(54) WASTEWATER TREATMENT METHOD

(71) Applicant: Sumitomo Chemical Company, Limited, Chuo-ku, Tokyo (JP)

(72) Inventors: Kyosuke SODEYAMA, Niihama-shi, Ehime (JP); Hajime YOSHINO, Niihama-shi, Ehime (JP); Shingo YAMAUCHI, Niihama-shi, Ehime (JP); Yusuke MIKAMI, Ichihara-shi, Chiba (JP)

(21) Appl. No.: 18/032,003

(22) PCT Filed: Oct. 13, 2021
(86) PCT No.: PCT/JP2021/037845

§ 371 Date: Apr. 14, 2023

(30) Foreign Application Priority Data
Oct. 16, 2020 (JP) 2020-174934

(51) Int. Cl. C02F 1/72; C02F 1/04

(52) U.S. Cl. CPC C02F 1/725; C02F 2101/16; C02F 1/048; C02F 1/043

(57) ABSTRACT

A method for treating wastewater significantly reduces an ammonium ion concentration and COD of wastewater while reducing the amount of an oxidizing gas used. The method for treating wastewater containing ammonia nitrogen, and the method includes: a first step of discharging at least a part of the ammonia nitrogen from the wastewater; and a second step of subjecting first treated wastewater which is the wastewater that has been subjected to the first step to a wet oxidation treatment.

### TECHNICAL FIELD

The present invention relates to a method for treating wastewater containing ammonia nitrogen.

### BACKGROUND ART

As an example of a method for treating wastewater containing an organic substance, a catalytic wet oxidation method is known. Non-Patent Document 1 proposes a catalytic wet oxidation method in which a homogeneous catalyst containing copper ions is used as a catalyst and reaction is caused to proceed at an oxidation reaction temperature of 200° C. to 300° C.

Patent Document 1 proposes a method for oxidatively decomposing ammonia nitrogen into a nitrogen gas by subjecting wastewater containing ammonia nitrogen to a wet oxidation treatment at an oxidation reaction temperature of 100 to 180° C. using a solid catalyst.

### PRIOR ART DOCUMENTS

### Non-Patent Document

Non-Patent Document 1: Takagi, Tagashira, and Inagaki, “Wastewater treatment by catalytic method wet oxidation”, Environmental Technology Vol. 8 No. 2 pages 190 to 198 (1979)

### Patent Document

Patent Document 1: JP-A-7-328654 (published on Dec. 19, 1995)

### SUMMARY OF THE INVENTION

### Problems to be Solved by the Invention

However, in the method described in Non-Patent Document 1, although a COD reduction ratio is about 80 to 95%, an ammonium ion concentration after the wet oxidation treatment is increased as compared with that before the wet oxidation treatment. That is, in the method described in Non-Patent Document 1, oxidation of a nitrogen component proceeds up to a state of ammonia nitrogen and stops at the state of ammonia nitrogen.

In the method described in Patent Document 1, ammonia nitrogen can be caused to react with oxygen to form a nitrogen gas. However, a large amount of an oxidizing gas is required in order to oxidatively decompose ammonia nitrogen contained in wastewater to a nitrogen gas.

An aspect of the present invention has been made in view of the above problems, and an object of the present invention is to significantly reduce an ammonium ion concentration and COD of wastewater while reducing the amount of an oxidizing gas used.

### Means for Solving the Problems

In order to solve the above problems, a method for treating wastewater containing ammonia nitrogen according to an aspect of the present invention includes: a first step of discharging at least a part of the ammonia nitrogen from the wastewater; and a second step of subjecting first treated wastewater which is the wastewater that has been subjected to the first step to a wet oxidation treatment.

### Effect of the Invention

According to an aspect of the present invention, it is possible to significantly reduce an ammonium ion concentration and COD of wastewater while reducing the amount of an oxidizing gas used.

### BRIEF DESCRIPTION OF THE DRAWINGS

FIG. 1 is a diagram for explaining a flow of a wastewater treatment apparatus according to a first embodiment of the present invention.

FIG. 2 is a diagram for explaining a flow of a wastewater treatment apparatus according to a second embodiment of the present invention.

### MODE FOR CARRYING OUT THE INVENTION

### First Embodiment

(Configuration of Wastewater Treatment Apparatus)

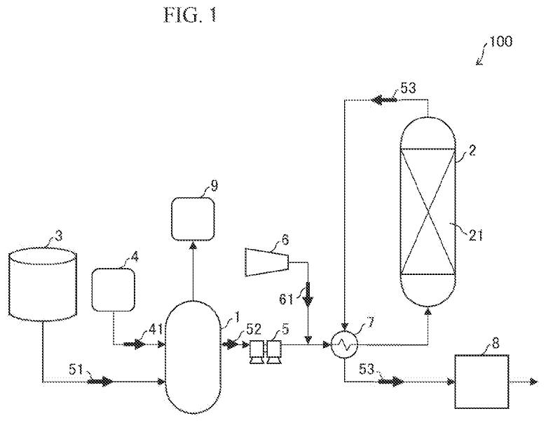

Hereinafter, an embodiment of the present invention will be described in detail. First, a wastewater treatment apparatus 100 used in a treatment method according to the embodiment of the present invention will be described with reference to FIG. 1. FIG. 1 is a diagram for explaining a flow of the wastewater treatment apparatus 100. The wastewater treatment apparatus 100 is an apparatus that treats wastewater (wastewater 51) containing ammonia nitrogen to reduce an ammonium ion concentration (NH₄⁺ concentration) and chemical oxygen demand (COD) of the wastewater 51.

As illustrated in FIG. 1, the wastewater treatment apparatus 100 includes a wastewater tank 3, an ammonia removal device 1 that treats the wastewater 51 supplied from the wastewater tank 3, and a first reactor 2 that treats first treated wastewater 52 discharged from the ammonia removal device 1. The wastewater 51 may be pretreated before treatment in the ammonia removal device 1. Examples of the pretreatment include a flocculation precipitation treatment and filtration separation, but are not limited thereto. The wastewater treatment apparatus 100 further includes a post-treatment device 8 that treats second treated wastewater 53 treated by the first reactor 2. Examples of the post-treatment performed by the post-treatment device 8 include a flocculation precipitation treatment, a biological treatment, an accelerated oxidation treatment, and activated carbon adsorption, but are not limited thereto. In particular, a biological treatment capable of treating a substance that cannot be removed by a wet oxidation treatment which is a chemical treatment is preferable.

The wastewater tank 3 is a tank that stores the wastewater 51 to be treated by the wastewater treatment apparatus 100. The ammonia nitrogen is a generic term for ammonium ions and ammonia dissolved in a liquid phase. The wastewater (wastewater 51) containing ammonia nitrogen according to the present invention contains ammonia nitrogen, and may further contain, for example, various organic substances or various inorganic substances. Note that the ammonia nitrogen contained in the wastewater 51 only needs to contain at least one of ammonium ions and ammonia. Examples of the various organic substances include methanol, ethanol, acetaldehyde, formic acid, acetone, phenol, and an organic phosphorus compound, but are not limited thereto. Examples of the various inorganic substances include a nitrogen compound (nitrous acid or the like) and a sulfur compound (hydrogen sulfide, sulfurous acid, or the like), but are not limited thereto. Among the various organic substances and the various inorganic substances, a substance to be oxidized for which the amount of oxygen required for oxidation is detected as chemical oxygen demand (COD) is collectively referred to as a COD component.

The ammonia removal device 1 is a device for performing a first step of removing at least a part of ammonia nitrogen from the wastewater 51. The ammonia removal device 1 is, for example, a stripping device, and heats the wastewater 51 and discharges (removes) at least a part of ammonia nitrogen as ammonia-containing steam. Heating of the wastewater 51 in the ammonia removal device 1 is performed, for example, using a heat source (not illustrated) such as an electric heater, but is not limited thereto. As a result, the wastewater 51 is heated to, for example, 80° C. or higher. The temperature of the heated wastewater 51 may be any temperature as long as the temperature is equal to or higher than a temperature at which ammonia volatilizes, but is preferably a temperature at which the wastewater 51 can maintain a boiling state.

The ammonia removal device 1 may include a unit (not illustrated) that supplies an inert gas such as nitrogen in order to prevent formation of an explosive mixed gas inside the device. FIG. 1 illustrates a case where the ammonia removal device 1 is a stripping device. In this case, the ammonia removal device 1 includes a pH adjuster supplying unit 4 and an ammonia collecting device 9. The ammonia removal device 1 can reduce the ammonium ion concentration of the wastewater 51 by 80% or more, 90% or more, or 99% or more.

The pH adjuster supplying unit 4 supplies a pH adjuster 41 that adjusts a pH of the wastewater 51 in the ammonia removal device 1 to basicity to the ammonia removal device 1. The pH adjuster 41 is, for example, a NaOH aqueous solution having any concentration, but may be any one as long as the pH adjuster 41 can adjust the pH of the wastewater to basicity. FIG. 1 illustrates an example in which the pH adjuster supplying unit 4 supplies the pH adjuster 41 to the ammonia removal device 1, but the configuration for adjusting the pH of the wastewater 51 is not limited to the above configuration. For example, the pH adjuster supplying unit 4 may supply the pH adjuster 41 to the wastewater tank 3 to adjust the pH of the wastewater 51 in the wastewater tank 3. Alternatively, the pH adjuster supplying unit 4 may supply the pH adjuster 41 to a circulation pipe disposed outside the ammonia removal device 1, such as a pipe extending from the ammonia removal device 1 and returning to the ammonia removal device 1 again. When the pH is precisely controlled, an acidic agent supplying unit that supplies an acidic agent such as sulfuric acid may be separately disposed.

For example, in the ammonia removal device 1, the pH adjuster supplying unit 4 supplies the pH adjuster 41 to the ammonia removal device 1 to adjust the pH of the wastewater 51 before heating to strong basicity of 11 or more. By adjusting the pH of the wastewater 51 before heating to strong basicity, ammonia is efficiently removed. In the first step, the pH of the wastewater 51 supplied to the ammonia removal device 1 gradually decreases as ammonia is removed. When a pH of the first treated wastewater 52 treated by the ammonia removal device 1 and discharged from the ammonia removal device 1 is 9.5 or more, it is sufficiently ensured that the pH of the wastewater 51 being treated by the ammonia removal device 1 is basic. Therefore, the pH of the first treated wastewater 52 is preferably 9.5 or more.

The ammonia collecting device 9 is a device that collects ammonia-containing steam discharged from the ammonia removal device 1. The ammonia collecting device 9 includes, for example, a multi-pipe heat exchanger (condenser), and can condense a part of the ammonia-containing steam to collect the condensed ammonia-containing steam as ammonia water. The ammonia collecting device 9 may also collect uncondensed ammonia-containing steam as an ammonia gas. The collected ammonia water and ammonia gas can be reused in a process for producing a substance using ammonia as a raw material. Alternatively, the ammonia collecting device 9 may supply the ammonia water condensed in the ammonia collecting device 9 to the ammonia removal device 1 again. This makes it possible to collect only the ammonia gas.

The first reactor 2 is a reactor for performing a second step of subjecting the first treated wastewater 52 to a wet oxidation treatment. The wet oxidation treatment is a method for oxidizing an organic substance or a reducing inorganic substance dissolved or suspended in a liquid in a state where a liquid phase is maintained at a high temperature and a high pressure. The first reactor 2 performs the wet oxidation treatment under, for example, a treatment temperature of preferably 160° C. to 300° C., more preferably 170° C. to 290° C., still more preferably 180° C. to 280° C. and a pressure condition under which at least a part of the wastewater 51 in the first reactor 2 maintains a liquid phase. The first reactor 2 includes an oxidizing gas supplying unit 6 that supplies an oxidizing gas 61 required for an oxidation treatment, a pump 5 that pressurizes the first treated wastewater 52, and a heat exchanger 7.

The oxidizing gas 61 may be any gas such as oxygen, oxygen-enriched air, or air as long as the oxidizing gas 61 contains oxygen. The supply amount of the oxidizing gas 61 supplied by the oxidizing gas supplying unit 6 is determined based on COD (for example, COD_{Cr}) and an ammonium ion concentration of the first treated wastewater 52. For example, the supply amount of the oxidizing gas 61 per unit volume of the first treated wastewater 52 can be determined based on an oxygen supply amount calculated from the following formula (1).

Oxygen supply amount=(COD+[NH₄⁺]×A)×B (1)

Specifically, the oxygen supply amount is an oxygen supply amount required for oxidizing ammonia nitrogen and COD components of the first treated wastewater 52. In the above formula (1), COD is a value of chemical oxygen demand in the first treated wastewater 52. The chemical oxygen demand can be obtained, for example, by sampling the first treated wastewater 52 and measuring the chemical oxygen demand using any COD measuring device. As COD, for example, COD_{Cr} (mg/L) indicating oxygen demand by potassium dichromate in the first treated wastewater 52 can be used, but a value of COD by another oxidizing agent may be used. In the above formula (1), a value of A is, for example, 3.1. A value of B is preferably 1.01 or more and 1.8 or less, more preferably 1.1 or more and 1.5 or less, and is, for example, 1.1.

An example of a method for determining a value of A is described below. In a wet oxidation reaction, an oxidation reaction of ammonium ions is represented by, for example, the following formula (2).

4NH₄⁺+7O₂→4NO₃⁻+12H⁺+2H₂O (2)

Since a molar mass of O₂ is 32 g/mol and a molar mass of NH₄⁺ is 18 g/mol, a weight ratio between oxygen (O₂) to ammonium ions in the above formula (2) is (32×7)/(18×4)≈3.1. That is, in order to oxidize ammonia nitrogen of the first treated wastewater 52, about 3.1 times of oxygen in terms of weight ratio is required. That is, assuming that the oxidation reaction of ammonium ions occurs according to formula (2), a value of A is 3.1. Note that the oxidation reaction of ammonium ions is not limited to the aspect of the above formula (2), and a reaction according to an aspect of the following formula (3) can also occur.

4NH₄⁺+3O₂→2N₂+4H⁺+6H₂O (3)

A weight ratio between oxygen (O₂) and ammonium ions in the above formula (3) is (32×3)/(18×4)=1.3. That is, in order to oxidize ammonia nitrogen of the first treated wastewater 52, about 1.3 times of oxygen in terms of weight ratio is required. That is, assuming that the oxidation reaction of ammonium ions occurs according to formula (3), a value of A is 1.3.

When a large amount of organic nitrogen detected as COD is contained in the first treated wastewater 52 and the organic nitrogen is oxidized to NO₃⁻ through NH₄⁺, the supply amount of the oxidizing gas 61 can be determined based on an oxygen supply amount calculated from the following formula (4) instead of formula (1).

Oxygen supply amount={COD+TN×A′}×B (4)

In the above formula (4), TN is a value of the total nitrogen amount (mg/L) of treated wastewater. A molar mass of N is 14 g/mol. When N is oxidized to equimolar NH₄⁺ and then oxidized according to formula (2), a weight ratio between oxygen (O₂) and nitrogen (N) is (32×7)/(14×4)=4. Therefore, in order to oxidize a nitrogen component in the first treated wastewater 52, about four times of oxygen in terms of weight ratio is required. That is, assuming that the oxidation reaction of ammonium ions occurs according to formula (2), a value of A′ is 4.

A value of B is preferably 1.01 or more in consideration of acceleration of the oxidation reaction, a measurement error of COD, and the like. In addition, in order to reduce the supply amount of the oxidizing gas 61 as much as possible, a value of B is 1.8 or less, and more preferably 1.5 or less.

The ammonium ion concentration in the above formula (1) is a measured value obtained by measuring an ammonium ion concentration in the first treated wastewater 52. The ammonium ion concentration may be continuously measured between the ammonia removal device 1 and the pump 5, for example, by an ion electrode method. In addition, the ammonium ion concentration may be measured by sampling the first treated wastewater 52 and using ion chromatography, absorptiometry, potentiometry, or the like.

Usually, when wastewater containing ammonia nitrogen is directly subjected to a wet oxidation treatment, a large amount of oxygen is required to oxidize ammonia.

Meanwhile, in the treatment method of the present invention, the ammonium ion concentration of the first treated wastewater 52 is sufficiently reduced (80% or more or 90% or more) by the ammonia removal device 1. Therefore, as can be seen from the above formula (1) or (4), a required oxygen amount can be reduced as compared with a case where the wastewater 51 is directly subjected to a wet oxidation treatment.

In the treatment method of the present invention, the ammonium ion concentration of the wastewater 51 is sufficiently reduced by the first step. Therefore, only the COD components in the first treated wastewater 52 may be oxidized in the first reactor 2, and the oxygen supply amount may be determined by the following formula (5).

Oxygen supply amount=(COD)×B (5)

Note that when the wastewater 51 is directly wet-oxidized using the oxygen supply amount determined using the above formula (5), the amount of oxygen required for oxidation of NH₄⁺ is insufficient, and therefore a COD reduction ratio is reduced as compared with the treatment method of the present invention including the first step. That is, the treatment method of the present invention can improve the COD reduction ratio as compared with the treatment method for directly wet-oxidizing the wastewater 51 when the oxygen supply amount is the same in a range of a value of formula (5) or more and less than a value of formula (4).

The first reactor 2 may include a solid catalyst 21 in order to accelerate a reaction in the reactor. The whole inside of the first reactor 2 does not need to be filled with the solid catalyst 21, and there may be a non-catalyst portion where the solid catalyst 21 does not exist in the first reactor 2. That is, the second step includes either or both of a wet oxidation treatment in a non-catalytic state and a wet oxidation treatment in the presence of the solid catalyst 21. As the solid catalyst 21, an oxidation catalyst having activity and durability under an oxidation condition in a liquid phase is used. The solid catalyst 21 contains metal and/or an element compound of at least one kind of element. The element contained in the solid catalyst 21 is preferably selected from the group consisting of platinum, palladium, ruthenium, iridium, rhodium, gold, cerium, lanthanum, yttrium, praseodymium, neodymium, indium, copper, and manganese. By using the solid catalyst 21, efficiency of the oxidation reaction in the first reactor 2 can be improved.

The solid catalyst 21 is more preferably a ruthenium-supported catalyst in which metal ruthenium and/or a ruthenium compound is supported on a carrier. By using the ruthenium-supported catalyst as the solid catalyst 21, the efficiency of the oxidation reaction in the first reactor 2 can be further improved.

The ruthenium compound may be ruthenium oxide. By using ruthenium oxide, heat resistance, catalyst life, and efficiency of the oxidation reaction of the obtained solid catalyst 21 are improved. The carrier of the ruthenium-supported catalyst may be a carrier containing titanium oxide. The titanium oxide may be titanium oxide having a rutile type crystal structure (rutile type titanium oxide), titanium oxide having an anatase type crystal structure (anatase type titanium oxide), amorphous titanium oxide, or the like, or may be a mixture thereof. The carrier of the ruthenium-supported catalyst is more preferably rutile type titanium oxide. By using the rutile type titanium oxide, the heat resistance, catalyst life, and efficiency of the oxidation reaction of the obtained solid catalyst 21 are improved.

The heat exchanger 7 is a device for performing heat exchange between the first treated wastewater 52 and the second treated wastewater 53 in order to heat the first treated wastewater 52 and cool the second treated wastewater 53. Note that the first treated wastewater 52 may be heated by a start heat exchanger (not illustrated) or the like at the time of start of the plant. In addition, when a concentration of a substance to be oxidized in the first treated wastewater 52 is high and surplus energy is generated, a steam generator (not illustrated) or the like may be disposed to collect steam or the like. The steam generator may be disposed between the first reactor 2 and the heat exchanger 7, or between the heat exchanger 7 and the post-treatment device 8.

The post-treatment device 8 is a device for performing a post-treatment step of further reducing the amount of a pollutant such as an organic substance contained in the second treated wastewater 53 on the second treated wastewater 53. The pollutant is a generic term for substances whose amounts can be reduced in the post-treatment step, and includes an organic substance, a nitrogen compound, a sulfur compound, a phosphorus compound, a heavy metal, and the like. The post-treatment device 8 can decompose an organic substance remaining in the second treated wastewater 53 into a carbon dioxide gas and water, for example. The post-treatment device 8 can perform, for example, a biological treatment (biological treatment step) performed by a general aerobic treatment method, an anaerobic treatment method, or a combination thereof. In the biological treatment step, the nitrogen component remaining in the second treated wastewater 53 may be further reduced by combining the anaerobic treatment method and the aerobic treatment method. In addition, a biogas (methane) may be obtained from the organic substance by the anaerobic treatment.

Note that an ammonium ion concentration of the wastewater 51 may be 10,000 mg/L or more. The wastewater treatment apparatus 100 includes the ammonia removal device 1, and therefore can effectively reduce the ammonium ion concentration of the wastewater 51. Therefore, even when the ammonium ion concentration of the wastewater 51 is 10,000 mg/L or more, an ammonium ion concentration contained in wastewater that has been treated by the wastewater treatment apparatus 100 can be effectively reduced. Specifically, the wastewater treatment apparatus 100 can reduce the ammonium ion concentration by 80% or more, 90% or more, or 99% or more in the treatment up to the second step. In addition, by further including the post-treatment device 8, the wastewater treatment apparatus 100 can reduce the ammonium ion concentration by 90% or more, preferably 99% or more. When the ammonium ion concentration of the wastewater 51 is less than 10,000 mg/L, effectiveness of inclusion of the ammonia removal device 1 is low. Meanwhile, when the ammonium ion concentration of the wastewater 51 is 10,000 mg/L or more, the amount of ammonia nitrogen to be removed by the ammonia removal device 1 is large, and therefore the effectiveness of inclusion of the ammonia removal device 1 is high.

In addition, COD_{Cr} can also be used as an index of the amount of a substance to be oxidized among various organic substances and various inorganic substances contained in the wastewater 51. The wastewater 51 according to the present invention may have an ammonium ion concentration of 10,000 mg/L or more and a COD_{Cr} of 8,000 mg/L or more. The wastewater treatment apparatus 100 includes the ammonia removal device 1 and the first reactor 2, and therefore can effectively reduce the ammonium ion concentration and COD_{Cr}. Specifically, in the treatment up to the second step, the wastewater treatment apparatus 100 can reduce the ammonium ion concentration of the wastewater 51 by 80% or more, 90% or more, or 99% or more, and can reduce COD_{Cr} by 70% or more, 90% or more, or 99% or more. In addition, by further including the post-treatment device 8, the wastewater treatment apparatus 100 can reduce the ammonium ion concentration by 90% or more or 99% or more, and can reduce COD_{Cr} by 95% or more or 99% or more.

(Flow of Wastewater Treatment)

Hereinafter, a flow in which the wastewater 51 is treated by the wastewater treatment apparatus 100 will be described.

The wastewater 51 stored in the wastewater tank 3 is supplied to the ammonia removal device 1, as necessary, through a liquid property adjusting step in which the pH adjuster 41 adjusts the pH to basicity. The liquid property adjusting step may be performed in the ammonia removal device 1.

In the wastewater 51 that has been subjected to the liquid property adjusting step, at least a part of ammonia nitrogen is removed by the ammonia removal device 1 (first step). The first treated wastewater 52 which is the wastewater 51 that has been subjected to the first step is pressurized by the pump 5 and sent to the heat exchanger 7 together with the oxidizing gas 61 supplied from the oxidizing gas supplying unit 6. Note that the oxidizing gas supplying unit 6 may be disposed at a subsequent stage of the heat exchanger 7, and the oxidizing gas 61 may be supplied to the first treated wastewater 52 that has passed through the heat exchanger 7.

The first treated wastewater 52 is heated by a mixed fluid (second treated wastewater 53) of a high-temperature oxidizing liquid and a gas after the reaction discharged from the first reactor 2 and supplied to the first reactor 2. The first treated wastewater 52 supplied to the first reactor 2 is subjected to a wet oxidation treatment at high temperature and high pressure (second step). In the second step, the COD components and ammonia nitrogen contained in the first treated wastewater 52 are oxidized, for example, by coming into contact with the solid catalyst 21 (for example, a ruthenium-supported catalyst in which ruthenium oxide is supported on a carrier). The second treated wastewater 53 containing the first treated wastewater 52 that has been subjected to the oxidation treatment and a gas after the reaction is discharged from the first reactor 2.

The second treated wastewater 53 discharged from the first reactor 2 is decompressed by a pressure control valve (not illustrated) and then supplied to the post-treatment device 8, and the remaining COD components and ammonia nitrogen are further decomposed by, for example, a biological treatment.

(Summary of Effects of First Embodiment)

As described above, the treatment method of the first embodiment is a method for treating wastewater containing ammonia nitrogen, and is performed using the wastewater treatment apparatus 100. In addition, the wastewater treatment method of the first embodiment includes: the first step of discharging at least a part of the ammonia nitrogen from the wastewater 51; and the second step of subjecting the first treated wastewater 52 which is the wastewater 51 that has been subjected to the first step to a wet oxidation treatment.

According to this treatment method, at least a part of ammonia nitrogen can be removed in the first step. Therefore, the oxidizing gas 61 required in the second step can be reduced. In addition, by performing the wet oxidation treatment in the second step, ammonia nitrogen and COD components remaining in the wastewater 51 can be reduced. That is, the treatment method of the first embodiment can effectively reduce an ammonium ion concentration and COD of the wastewater 51 while reducing the amount of the oxidizing gas 61 used.

In addition, in the treatment method of the first embodiment, in the first step, the wastewater 51 is heated, and at least a part of the ammonia nitrogen is discharged as ammonia-containing steam from the wastewater 51 to be removed.

With the above configuration, by heating the wastewater 51 and removing ammonia nitrogen as ammonia, ammonia can be efficiently removed from the wastewater 51.

In addition, in the treatment method of the first embodiment, the first treated wastewater 52 has an ammonium ion concentration of 2,000 mg/L or less.

Since the ammonium ion concentration of the first treated wastewater 52 is 2,000 mg/L or less, the use amount of the oxidizing gas required in the wet oxidation in the second step can be significantly reduced as compared with a case where the wastewater 51 is directly subjected to the wet oxidation treatment.

In addition, the treatment method of the first embodiment further includes the liquid property adjusting step of adjusting the wastewater 51 so as to have strong basicity of pH 11 or more.

With the above configuration, by adjusting the liquid property of the wastewater 51 before heating to strong basicity, the liquid property of the wastewater 51 in the first step can be maintained at basicity, and the efficiency of ammonia removal in the ammonia removal device 1 can be improved.

In addition, in the treatment method of the first embodiment, the pH of the first treated wastewater 52 is 9.5 or more.

With the above configuration, by setting the pH of the first treated wastewater 52 to 9.5 or more, the liquid property of the wastewater 51 in the first step in the ammonia removal device 1 can be maintained sufficiently at basicity, and the efficiency of ammonia removal in the ammonia removal device 1 can be improved.

In addition, the treatment method of the first embodiment further includes the post-treatment step of performing a post-treatment on the second treated wastewater 53 which is the wastewater 51 that has been subjected to the second step to reduce the amount of a pollutant in the second treated wastewater 53.

With the above configuration, even when ammonia nitrogen and COD components remain in the second treated wastewater 53 after the second step, the values of remaining ammonia nitrogen and remaining COD can be further reduced by the post-treatment such as a biological treatment.

In addition, in the treatment method of the first embodiment, the second step is performed under a condition of using one or more kinds of the solid catalysts 21 containing metal and/or an element compound of at least one kind of element. The element contained in the solid catalyst 21 is selected from the group consisting of platinum, palladium, ruthenium, iridium, rhodium, gold, cerium, lanthanum, yttrium, praseodymium, neodymium, indium, copper, and manganese.

With the above configuration, by catalyzing the reaction in the second step using the solid catalyst 21, the efficiency of the oxidation reaction can be improved. This makes it possible to further reduce the ammonium ion concentration and the COD in the second step.

In addition, in the treatment method of the first embodiment, the solid catalyst 21 is a ruthenium-supported catalyst in which metal ruthenium and/or a ruthenium compound is supported on a carrier.

With the above configuration, the performance of the catalyst can be improved.

In addition, in the treatment method of the first embodiment, the ruthenium compound is ruthenium oxide. With the above configuration, the performance of the catalyst can be improved.

In addition, in the treatment method of the first embodiment, the carrier is a carrier containing titanium oxide. With the above configuration, the performance of the catalyst can be improved.

In addition, in the treatment method of the first embodiment, the titanium oxide is rutile crystal type titanium oxide. With the above configuration, the performance of the catalyst can be improved.

In addition, in the treatment method of the first embodiment, the ammonium ion concentration of the wastewater 51 is 10,000 mg/L or more. By treating the wastewater 51 having an ammonium ion concentration of 10,000 mg/L or more by the treatment method of the first embodiment, it is possible to effectively reduce the ammonium ion concentration of the wastewater 51 while significantly reducing the amount of an oxidizing gas used.

In the treatment method of the first embodiment, the ammonium ion concentration of the wastewater 51 is 10,000 mg/L or more, and the COD_{Cr} of the wastewater 51 is 8,000 mg/L or more. By treating the wastewater 51 having the above configuration by the treatment method of the first embodiment, it is possible to effectively reduce the ammonium ion concentration and COD_{Cr} of the wastewater 51 while reducing the amount of an oxidizing gas used.

In addition, the treatment method of the first embodiment further includes an ammonia collecting step of collecting ammonia-containing steam discharged in the first step.

With the above configuration, ammonia nitrogen contained in the wastewater 51 can be collected as ammonia and reused in a process of producing a substance using ammonia as a raw material.

### Second Embodiment

Another embodiment of the present invention will be described below. Note that, for convenience of description, a member having the same function as the member described in the above embodiment is denoted by the same reference numeral, and the description thereof will not be repeated.

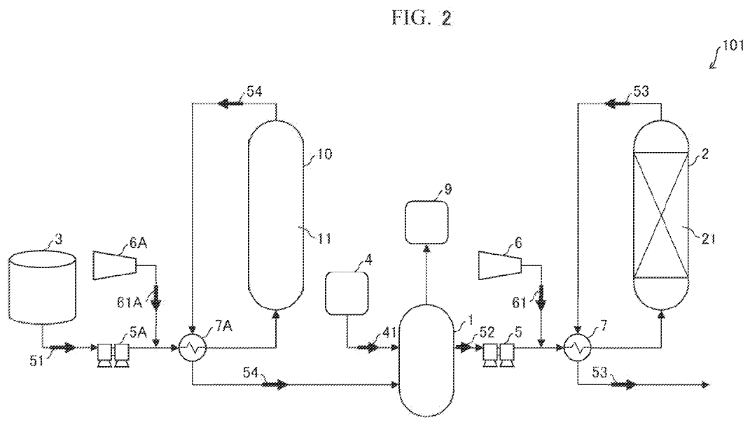

First, a wastewater treatment apparatus 101 used in a treatment method according to a second embodiment of the present invention will be described with reference to FIG. 2. FIG. 2 is a diagram for explaining a flow of the wastewater treatment apparatus 101.

The wastewater treatment apparatus 101 is different from the wastewater treatment apparatus 100 of the first embodiment in including a second reactor 10. Note that the post-treatment device 8 is not illustrated in FIG. 2, but the wastewater treatment apparatus 101 may include the post-treatment device 8 similarly to the wastewater treatment apparatus 100.

The second reactor 10 is a reactor for performing a preliminary wet oxidation step of subjecting the wastewater 51 to a wet oxidation treatment before the first step. The second reactor 10 wet-oxidizes the wastewater 51 under a non-catalytic condition or under a condition using a homogeneous catalyst 11. The second reactor 10 performs the wet oxidation treatment under a treatment temperature of preferably 160° C. to 280° C., more preferably 180° C. to 260° C. and a pressure condition under which the wastewater 51 in the second reactor 10 maintains a liquid phase. The second reactor 10 includes an oxidizing gas supplying unit 6A that supplies an oxidizing gas 61A required for an oxidation treatment in the second reactor 10, a pump 5A that pressurizes the wastewater 51, and a heat exchanger 7A. The wastewater 51 is subjected to an oxidation treatment in the second reactor 10 and supplied to the ammonia removal device 1 as preliminary-oxidized wastewater 54.

The homogeneous catalyst 11 is, for example, a catalyst containing metal and/or an element compound of at least one kind of element. The element contained in the homogeneous catalyst 11 can be selected from the group consisting of copper, vanadium, iron, tin, chromium, and zinc.

In the preliminary wet oxidation step, organic nitrogen contained in the wastewater 51 can be oxidized to a state of ammonium ions (NH₄⁺) that can be removed by the ammonia removal device 1 by wet oxidation under a non-catalytic condition or using the homogeneous catalyst. That is, at least a part of the organic nitrogen contained in the wastewater 51 can be removed by the ammonia removal device 1 by being subjected to the preliminary wet oxidation step. Note that the organic nitrogen means nitrogen contained in an amino group, a peptide bond, or the like in an organic substance in the wastewater 51.

The wastewater treatment apparatus 101 according to the second embodiment can reduce the nitrogen content of the wastewater 51 due to the first step similarly to the wastewater treatment apparatus 100 according to the first embodiment. As a result, the supply amount of an oxidizing gas as the whole wastewater treatment apparatus 101 according to the second embodiment is reduced as compared with that of a wet oxidation apparatus not including the ammonia removal device 1.

In addition, when a high-level treatment is performed with solid catalyst wet oxidation (second step) without the preliminary wet oxidation step, both COD components and organic nitrogen in the wastewater 51 are oxidized at a high ratio, and the organic nitrogen can be further oxidized (for example, up to NO₃⁻) via NH₃. Therefore, when the preliminary wet oxidation step is not performed in a treatment of wastewater containing a large amount of organic nitrogen, the amount of oxygen required for oxidation is larger than that when the preliminary wet oxidation step is performed. That is, in a case where organic nitrogen-containing wastewater is treated, the wastewater treatment apparatus 101 according to the second embodiment can further reduce the required oxygen amount as compared with the wastewater treatment apparatus 100 according to the first embodiment.

In addition, by removal of organic nitrogen oxidized to ammonium ions in the first step, the amount of oxygen required for oxidizing ammonia nitrogen or organic nitrogen and COD components in the second step is reduced. Therefore, the supply amount of the oxidizing gas 61 to the first reactor 2 can be reduced.

(Flow of Wastewater Treatment)

Hereinafter, a flow in which the wastewater 51 is treated by the wastewater treatment apparatus 101 will be described.

The wastewater 51 stored in the wastewater tank 3 is pressurized by the pump 5A and sent to the heat exchanger 7A together with the oxidizing gas 61A supplied from the oxidizing gas supplying unit 6A. Note that the oxidizing gas supplying unit 6A may be disposed at a subsequent stage of the heat exchanger 7A. The wastewater 51 is heated by a mixed fluid (preliminary-oxidized wastewater 54) of a high-temperature oxidizing liquid and a gas after the reaction discharged from the second reactor 10 and supplied to the second reactor 10. The wastewater 51 supplied to the second reactor 10 is subjected to a wet oxidation treatment at high temperature and high pressure (preliminary wet oxidation step). In the preliminary wet oxidation step, COD components and organic nitrogen contained in the wastewater 51 are oxidized, for example, by coming into contact with the homogeneous catalyst 11. In the preliminary wet oxidation step, the organic nitrogen can be oxidized to ammonia nitrogen. The preliminary-oxidized wastewater 54 containing the wastewater 51 that has been subjected to the oxidation treatment and a gas after the reaction is discharged from the second reactor 10.

The preliminary-oxidized wastewater 54 discharged from the second reactor 10 is supplied to the ammonia removal device 1, as necessary, through a liquid property adjusting step in which the pH adjuster 41 adjusts the pH to basicity. The liquid property adjusting step may be performed in the ammonia removal device 1.

In the wastewater 51 that has been subjected to the liquid property adjusting step, at least a part of ammonia nitrogen is removed by the ammonia removal device 1 (first step). The first treated wastewater 52 which is the wastewater 51 that has been subjected to the first step is pressurized by the pump 5 and sent to the heat exchanger 7 together with the oxidizing gas 61 supplied from the oxidizing gas supplying unit 6. Note that the oxidizing gas supplying unit 6 may be disposed at a subsequent stage of the heat exchanger 7.

The first treated wastewater 52 is heated by a mixed fluid (second treated wastewater 53) of a high-temperature oxidizing liquid and a gas after the reaction discharged from the first reactor 2 and supplied to the first reactor 2. The first treated wastewater 52 supplied to the first reactor 2 is subjected to a wet oxidation treatment at high temperature and high pressure (second step). In the second step, the COD components and ammonia nitrogen contained in the first treated wastewater 52 are oxidized, for example, by coming into contact with the solid catalyst 21 (for example, a ruthenium-supported catalyst in which ruthenium oxide is supported on a carrier). The second treated wastewater 53 containing the first treated wastewater 52 that has been subjected to the oxidation treatment and a gas after the reaction is discharged from the first reactor 2.

The treatment method of the second embodiment further includes the preliminary wet oxidation step of subjecting wastewater containing a nitrogen compound in a form other than ammonia nitrogen to a wet oxidation treatment before the first step to obtain ammonia nitrogen-containing wastewater to be supplied to the first step. The preliminary wet oxidation step is a step of wet-oxidizing the wastewater 51 under a non-catalytic condition or under a condition using the homogeneous catalyst 11 containing metal and/or an element compound of at least one kind of element. The element contained in the homogeneous catalyst 11 is selected from the group consisting of copper, vanadium, iron, tin, chromium, and zinc.

(Demonstration Test)

Hereinafter, a laboratory test for demonstrating an effect of the wastewater treatment method using the wastewater treatment apparatus 100 of the first embodiment will be described.

Example is an example in which test wastewater 51S is treated by a method including the liquid property adjusting step, the first step, and the second step. Comparative Example is an example in which the wastewater 51S is treated by a method including only the second step.

Data for the wastewater 51S is as follows.

pH: 1.86

COD_{Cr}: 24,700 mg/L

NH₄⁺ concentration: 123,000 mg/L

Liquid amount: 352 ml (0.5 kg)

### Example

First, in Example, as a treatment corresponding to the liquid property adjusting step, the wastewater 51S was put into a stainless steel container, and 250 g of a 48% NaOH aqueous solution was added thereto. By this operation, the pH of the mixed solution containing the wastewater 51S became 12.1.

Next, as a treatment corresponding to the first step (experimental first step), 745 g of the mixed solution was put into a stainless steel container, and heated from the outside of the stainless steel container under atmospheric pressure using a heating medium. The mixed solution in the stainless steel container started to boil when reaching about 100° C. Heating was continued for 60 minutes while the boiling state was maintained. Water evaporated during the experimental first step was collected, cooled, and returned to the mixed solution after the first experimental step. Data of first treated wastewater 52S which is the mixed solution after the experimental first step are as follows.

pH: 9.68

COD_{Cr}: 19,000 mg/L

NH₄⁺ concentration: 1,200 mg/L

Liquid amount: 439 ml

As a result of calculating an NH₄⁺ removal ratio after the first experimental step using the following formula (6), the NH₄⁺ removal ratio after the experimental first step was about 99%.

{1−(liquid amount of first treated wastewater 52S×NH₄⁺ concentration of first treated wastewater 52S)/(liquid amount of wastewater 51S×NH₄⁺ concentration of wastewater 51S)}×100 (6)

Next, a treatment corresponding to the second step (experimental second step) was performed using an autoclave. 150 ml (197.9 g) of the first treated wastewater 52S was put into an autoclave, and a catalyst constituted by titanium oxide supporting ruthenium oxide was added thereto such that a Ru concentration in the first treated wastewater 52S was 500 ppm. In addition, 24.9 g/L of oxygen was supplied as air into the autoclave. Note that, as the amount of supplied oxygen, a result obtained by calculation using A=3.1 and B=1.1 in the above formula (1) was used. The experimental second step was performed at 260° C. under an environment where an external fluid did not flow in and out. The autoclave was heated by an electric heater from the outside of the autoclave.

After the experimental second step, cooling and depressurization were performed, and second treated wastewater 53S was taken out from the autoclave. The second treated wastewater 53S had a COD reduction ratio of 99% and an NH₄⁺ concentration equal to or lower than a detection limit.

### Comparative Example

In Comparative Example, the wastewater 51S was treated by performing only the second step. In a similar manner to Example, 150 ml (197.9 g) of the wastewater 51S was put into an autoclave, and a catalyst constituted by titanium oxide supporting ruthenium oxide was added thereto such that a Ru concentration in the wastewater 51S was 500 ppm. In addition, 446.6 g/L of oxygen was supplied as air into the autoclave. Note that, as the amount of supplied oxygen, a result obtained by calculation using A=3.1 and B=1.1 in the above formula (1) was used.

After the second experimental step, cooling and depressurization were performed, and second treated wastewater 53S was taken out from the autoclave. The second treated wastewater 53S had a COD reduction ratio of 99% and an ammonia removal ratio prediction value of 89%.

<Summary of Demonstration Test>

From the above-described demonstration test, the amount of oxygen required to achieve a desired COD reduction ratio and ammonia removal ratio was 446.6 g/L in Comparative Example, whereas the amount of oxygen was 24.9 g/L in Example. That is, it was demonstrated that Example which is an embodiment of the present invention can reduce the oxygen supply amount as compared with Comparative Example.

### DESCRIPTION OF REFERENCE SIGNS

1 Ammonia removal device
2 First reactor
3 Wastewater tank
4 pH Adjuster supplying unit
6, 6A Oxidizing gas supplying unit
8 Post-treatment device
9 Ammonia collecting device
Second reactor
11 Homogeneous catalyst
21 Solid catalyst
41 pH Adjuster
51 Wastewater
52 First treated wastewater
53 Second treated wastewater
54 Preliminary-oxidized wastewater
61, 61A Oxidizing gas
100, 101 Wastewater treatment apparatus

1. A method for treating wastewater containing ammonia nitrogen, the method comprising:
a first step of discharging at least a part of the ammonia nitrogen from the wastewater; and
a second step of subjecting first treated wastewater which is the wastewater that has been subjected to the first step to a wet oxidation treatment.

2. The method according to claim 1, wherein in the first step, the wastewater is heated, and at least a part of the ammonia nitrogen is discharged as ammonia-containing steam from the wastewater to be removed.

3. The method according to claim 1, wherein the first treated wastewater has an ammonium ion concentration of 2,000 mg/L or less.

4. The method according to claim 1, further comprising a liquid property adjusting step of adjusting the wastewater so as to have strong basicity of pH 11 or more.

5. The method according to claim 1, wherein the first treated wastewater has a pH of 9.5 or more.

6. The method according to claim 1, further comprising a post-treatment step of performing a post-treatment on second treated wastewater which is the wastewater that has been subjected to the second step to reduce an amount of a pollutant in the second treated wastewater.

7. The method according to claim 1, wherein
the second step is performed under a condition of using one or more kinds of solid catalysts containing metal and/or an element compound of at least one kind of element, and
the element contained in the solid catalyst is selected from the group consisting of platinum, palladium, ruthenium, iridium, rhodium, gold, cerium, lanthanum, yttrium, praseodymium, neodymium, indium, copper, and manganese.

8. The method according to claim 7, wherein the solid catalyst is a ruthenium-supported catalyst in which metal ruthenium and/or a ruthenium compound is supported on a carrier.

9. The method according to claim 8, wherein the ruthenium compound is ruthenium oxide.

10. The method according to claim 9, wherein the carrier is a carrier containing titanium oxide.

11. The method according to claim 10, wherein the titanium oxide is rutile crystal type titanium oxide.

12. The method according to claim 1, wherein the wastewater has an ammonium ion concentration of 10,000 mg/L or more.

13. The method according to claim 12, wherein the wastewater has COD_{Cr} of 8,000 mg/L or more.

14. The method according to claim 2, further comprising an ammonia collecting step of collecting ammonia-containing steam discharged in the first step.

15. The method according to claim 1, further comprising a preliminary wet oxidation step of subjecting wastewater containing a nitrogen compound in a form other than ammonia nitrogen to a wet oxidation treatment before the first step to obtain ammonia nitrogen-containing wastewater to be supplied to the first step, wherein
the preliminary wet oxidation step is a step of wet-oxidizing the wastewater under a non-catalytic condition or under a condition using a homogeneous catalyst containing metal and/or an element compound of at least one kind of element, and
the element contained in the homogeneous catalyst is selected from the group consisting of copper, vanadium, iron, tin, chromium, and zinc.
